(19) United States
(12) Patent Application Publication
(10) Pub. No.: US 2006/0222754 A1
(43) Pub. Date: Oct. 5, 2006

(54) Product and method for enhancing the appeal, and dietary value of foodstuff

(76) Inventor: Norman S. Singer, Highland Park, IL (US)

Correspondence Address: David G. Rosenbaum;ROSENBAUM & ASSOCIATES, P.C., Suite #380, 650 Dundee Road, Northbrook, IL, 60062, US

(21) Appl. No.: 11/396,881

(22) Filed: Apr. 3, 2006

Related U.S. Application Data
(60) Provisional application No. 60/668,114, filed on Apr. 4, 2005.

(51) Int. Cl. A23G 3/00

(52) U.S. Cl. 426/660

(57) ABSTRACT

A product and method by which a range of foodstuff products may be produced which are very pleasant in taste and texture, and therefore, pleasant to eat, and which contain a sufficiency of soluble dietary fiber to effectively supplement the typically low fiber dietary intake. By adding a low viscosity, non-digestible fiber either along or in a syrup composition, foodstuffs may be amended in such a manner as to increase dietary fiber intake without adversely affecting the palatability of the foodstuffs.

### CROSS-REFERENCE TO RELATED INVENTIONS

This Application relates to and claims priority from U.S. Provisional Application Ser. No. 60/668,114 filed Apr. 4, 2005.

### FIELD OF THE INVENTION

The present invention relates generally to products and methods for improving the nutritional, textural and functional properties of sugars, sugar syrups and products made therefrom.

### BACKGROUND OF THE INVENTION

The flavor characteristic of sweetness is one of the most pleasing taste experiences to humans. Sadly, we have found that this pleasure comes with many associated physiological maladies. For more than thirty years, the high simple sugar content of the North American diet has been recognized as creating or contributing to a variety of health challenges, including dental caries, diabetes, and obesity. Consequently, alternatives have been desired and sought. Alternative sweeteners, such as fructose, fruit syrups and the less common sugars such as erythritol, isomaltitol, and trehalose as well as high-intensity sweeteners, each seem to offer certain health benefits. Unfortunately, the functional properties of these alternative sugars and sweeteners are so different from those of sucrose, that it has not been possible to replicate the traditional flavor and textural characteristics in foodstuff made with these alternative sweeteners.

During this same time period, the significance of dietary fiber has become well recognized, as has the generalized deficiency of dietary fiber in most dietary regimens. This deficiency has also produced negative consequences for general health, including constipation, irritable bowel syndrome (IBS), diverticular disease, Crohn's Disease, ulcerative colitis, and gastrointestinal cancers. It is generally understood and accepted by medical practitioners in this field that gastrointestinal health is promoted by a moderately high rate of fecal transfer which is greatly facilitated by sufficient daily levels of dietary fiber.

While many consumable products based on dietary fiber have been introduced in recent years, they are characteristically lacking in taste and palatability and less than pleasant to consume, making routine consumption of such unpalatable products the exception rather than the rule. Consequently, the problem persists. For example, some dietary fiber supplements dissolve slowly and/or incompletely, so that the freshly-prepared slurry is gritty and unpleasant to ingest. If this preparation is allowed to stand, the grittiness decreases, but the viscosity increases, again producing an unpleasant experience. Other dietary fiber supplements produce very high viscosities when concentrated, such as occurs in the colon, thereby retarding the rate of fecal passage, a condition which is opposite to the desired acceleration of fecal transfer rate. Still other such products are fermented in the colon, producing gas which is not only uncomfortable and frequently embarassing, but which can also drive urgency for bowel evacuation.

It is therefore an objective of this invention to provide a product and method by which a range of food products may be produced which are very pleasant in taste and texture, and therefore, pleasant to eat, and which contain a sufficiency of soluble dietary fiber to effectively supplement the typically low fiber dietary intake, without compromising the overall objective of promoting a healthy fecal transfer rate and without flatulence or gaseous effulgence.

Currently, the best-known dietary fiber supplement products available in the market include; psillium seed extract (“METAMUCIL”), methyl cellulose (“CITRUCEL”), and partially hydrolyzed guar gum (“BENEFIBER”). However, other entrants into this arena have also made their appearance in the last decade. As an example, a little more than a decade ago, the Matsutani Company introduced a novel indigestible dextrin (synonymously referred to herein also as “dextrin”) derived form corn marketed under the trademark FIBERSOL 2. FIBERSOL-2 is a soluble dietary fiber (90% min DSB) and is produced from cornstarch by pyrolysis and subsequent enzymatic treatment to purposefully convert a portion of the normal alpha-1,4 glucose linkages to random 1,2-, 1,3-, and 1,4-alpha or beta linkages. The human digestive system effectively digests only alpha 1,4-linkages; therefore the other linkages render the molecules resistant to digestion. Thus, FIBERSOL-2 is GRAS (21CFR §170.30) as maltodextrin, resistant to human digestion, and conforms to all working industrial and scientific definitions of dietary fiber. It is an off-white powder which is clear and transparent in 10% solution and resists both enzymatic and non-enzymatic browning. It is water soluble up to 70% (w/w) at 20 degrees Centigrade. FIBERSOL-2 brand of maltodextrin has excellent dispersibility, very low hygroscopicity, and is stable in acid, heat/retort processing and freeze/thaw stable. It has very low viscosity of 15 cps in 30% solution at 20 degrees Centigrade. Its sweetness is low, on the range of <10% of sucrose at 30% T.S. Typical chemical properties of FIBERSOL-2 brand of maltodextrin include dietary fiber, 90% minimum DSB in accordance with AOAC method 2001.03, a moisture content of 5% maximum, no protein, no fat, DE between 8-12.5, pH 4.0-6.0 and 4.0 calories per gram (U.S.).

The FIBERSOL-2 brand of dextrin is described in several patents assigned to Matsutani, including: U.S. Pat. Nos. 5,358,729, 5,364,652, 5,380,717, 5,410,035, 5,472,732, 5,519,011, 5,595,773, 5,629,036, 5,698,437, which are hereby incorporated by reference as describing indigestible dextrin useful with the present invention.

While the FIBERSOL-2 brand of indigestible dextrin is provided as an example of a low viscosity dietary fiber (LVDF) and the embodiments of the present invention are set forth in their best mode with reference to the FIBERSOL-2 brand of dextrin, it is intended that any LVDF will exhibit utility in the present invention. By “any LVDF” we mean any material that has physical, functional and biological properties substantially to those describe in the Matsutani references, incorporated herein by reference.

In all of this, they not only detail the means of its manufacture, and describe its several claimed health and functional benefits, including: 90% Dietary Fiber, high solubility, low viscosity, absence of taste or flavor, moderates post-prandial rise in serum glucose, increases fecal volume, increases fecal frequency from about 0.5 to about 1 time per day, increases the population of the beneficial Bifidus bacteria in the colon, reduces serum triglyceride and cholesterol levels and produces freeze-thaw stable solutions.

In addition to describing the health and functional benefits, the foregoing patents provide a comprehensive list of foodstuffs with which dextrin may be used, including: black tea, cola drinks, orange juice, sports drinks, milk shakes, ice cream, fermented skimmed milk, hard yogurt, coffee whitener powder, candy, chewing gum, sweet chocolate (bar type), custard cream (panna-cotta type), orange jelly, strawberry jam, apple jam, bean jam, sweet jelly of beans, cereals, spaghetti, white bread, American donuts, wheat flower replacer, butter cookies, pound cake, sponge cake, apple pie, corn cream soup, retorted pouch curry, beef stew, non-oil dressing, dressing (MIRACLEWHIP type), mayonnaise, peanut butter, cheese powder, cream cheese, white sauce, meat sauce, beef and pork sausage, corned beef, hamburger steak, hamburger patty, liver paste, pizza, omelets, filing of meat pie, filling of Chinese dumpling, kamaboko, black berry liquor, dog food, cat food, pig feed, feed for broiler poultry or feed for laboratory rodent.

### SUMMARY OF THE INVENTION

However, in all of these product descriptions, they seem to have been focused upon demonstrating that their novel material could be added to foods (as a means of adding dietary fiber) without jeopardy. This rigid focus seems to have prevented them from seeing several surprising attributes of this material that can actually add new values to foods and other products. This discovery forms the foundation of the set of related inventions described herein.

For example, we found that, when low viscosity dietary fiber (“LVDF”) in the form of dextrin (Matsutani, FIBERSOL-2) was prepared as a high solids syrup (hereinafter referred to synonymously as “LVDF syrup” or “HSS”), this LVDF syrup was found to demonstrate surprising new properties. Most especially interesting is that the inventive syrup, prepared in the manner described below, displays a remarkable set of functional attributes, including a low viscosity (even at very high concentrations), the capacity to confer pleasing mouth-feel, (this consideration includes both the consistency and mouth-feeling factors of liquid syrups and the crunchy textures and mouth feeling factors of dry, solid matrices). As well, its surprisingly low Equilibrium Relative Humidity (ERH) contributes characteristics to dry sugar matrices to which it is added. By “low Equilibrium Relative Humidity (ERH)” is meant that set of physical properties which, at any given moisture content, causes such syrups (or dry products prepared therefrom) to tend to loose, rather than hold onto or pick up moisture, in comparison to conventional syrup materials. This surprising attribute has been found to be remarkably versatile in its usefulness.

The simplest new utility we found in the character of the syrup itself. That is, we found that when an LVDF syrup is prepared (65 to 70% solids content), it has a pouring character and mouthfeel that was almost identical to those of maple syrup.

When their long list of foods in the cited Matsutani patents is reviewed, no “syrup” product can be found. Therefore, no advantage of such a syrup can have been discovered by that inventor.

Further, Matsutani did not see the possibility (let alone the attractiveness) of a syrup that would have the sensory character of maple syrup, yet be high in fiber and virtually non-glycemic. Such products have been prepared by the inventor, using the inventive syrup alone, as well as blends of Erythritol, fructose and LVDF syrup.

Then we found that when the inventive syrup was used (in lieu of corn syrup) to stabilize a sucrose hard candy, the resulting candy is superior to conventional corn-syrup doctored hard candies.

Candy ‘Doctors’:

It has long been known that when a sucrose solution is boiled, its solids content increases, and consequently, the temperature at which it boils also increases, and that, further, as the solids content increases, the physical character of the cooled product also changes in predictable ways. Standard curves are available in the industry relating temperature of boiling to solids content of the boiling syrup, and to the resulting character of the cooled product. It is generally taken that at a temperature of about 300° F., the moisture content is below about 2%. At this level of dryness, the syrup, when cooled will form a crisp glass known as “hard candy”. However, it will shortly thereafter spontaneously degrade to a mass of “sandy” granules. That is, the glass will crystallize. Long ago it was found that this product disaster can be averted by the replacement in the original syrup of about 20 to 30% of the sucrose by corn syrup. The corn syrup was called a “Candy Doctor”. The use of corn syrup (or sometimes “invert sugar”—that is sucrose that has been hydrolyzed to its component simple sugars, glucose and fructose) has, since that early time, been standard practice in the candy industry. The ‘penalty’ of this standard practice (a certain stickiness, especially to the teeth) is a factor to which the industry has become accommodated that is, it seems to have become ignored.

It should be noted that, while Matsutani's U.S. Pat. No. 5,364,652 does mention the use of their dextrin in the manufacture of a “candy”, this product does not teach the utility we have found. In that example, they seemed to have focused their attention on replacing sucrose and so repeated the conventional practice of including corn syrup in its preparation. As well, the resulting mixture was cooked only to “Bx 80” (“Bx” stands for “Brix”, a measure of total solids in solution) before cooling. Thus, the candy still contained 20% moisture, and, would therefore have had the character of a caramel rather than a hard candy, which has a typical moisture content of which is in the range of 0 to 3%. Therefore we conclude that the utility we found had not been found by Matsutani.

Even more significantly, in none of the Matsutani references is there the suggestion or teaching that their indigestible dextrin could serve as a corn syrup (or invert sugar) replacement or as an alternative “Candy Doctor” to lend new dietary properties to the foodstuffs.

We subsequently evaluated the effects produced by adding the inventive syrup, or dry dextrin to a variety of beverages and confections. We were surprised to find that, when added even at low levels (0.5 to 10%) to all of these products, the amended products tended to show the same qualitative improvements, namely, the flavors in the LVDF-added products displayed a mellower flavor, with a more well-blended aroma than the original product. This kind of qualitative enhancement is very highly prized. It is conventionally found in only the most costly teas, and the finer wines and chocolates. This novel finding, therefore, has great economic potential.

The following is a partial list, intended to be illustrative of the utility of the present invention:
As an ingredient in edible syrup, of solids content sufficiently high to be stable at room temperature, and that has a fluid character and a mouthfeel virtually identical to maple syrup. Such syrups being prepared from either the inventive syrup alone, or blends of uncommon sugars and the inventive syrup.
As a novel ‘Candy Doctor’ for sucrose-based confections; producing a cleaner-biting (less sticking-to-the-teeth) candy ‘glass’ than found in conventional hard candy preparations.
As a ‘doctor’ for such highly hygroscopic sugars as erythritol, palatinate, Fructose, the inventive syrup dominates this property, enabling (for the first time) toffees and hard candies (and hard candy shells) from this group of desirable but still uncommon sugars.
As a ‘doctor’ that confers a certain ‘shortness’ of texture usually encountered in confections that have a high intrinsic fat content, such as pralines, nut brittles and fried bananas.
As a ‘doctor’ that induces a rapid set to hard candies and hard candy coatings.
As an enhancer for the flavors of a wide range of beverages; creating a mellowness and blendedness that is highly-prized and usually found only at the peak of fruit ripeness, or after long aging.
As an enhancer for the flavors of a wide range of confections; creating a mellowness and blendedness that is highly-prized and usually found in only the highest priced products.
As a carrier for fragile flavors, (and other heat-labile biological materials) that then can be dried far more readily and more gently than with conventional carriers or supports, while retaining rapid, facile dissolution.

It can be seen in their U.S. Pat. No. 5,358,729 that Matsutani's consideration of solids content vs Viscosity was rather narrow, as demonstrated in FIG. 1 of that document:

### BRIEF DESCRIPTION OF THE FIGURES

FIG. 1 is table identifying the different stages of sugar syrup in candy making.

FIG. 2 is a graph showing the correlation of viscosity to temperature for gum Arabic, maltodextrin (DE10), FIBERSOL-2 and sucrose.

FIG. 3 is a graph showing the correlation of concentration with viscosity derived for FIBERSOL-2.

### DETAILED DESCRIPTION OF THE INVENTION

Simply, we found that it was possible to prepare a syrup consisting of 60 to 70% FibersSol solids and water, and that this syrup is shelf stable, and it has a fluid character virtually identical to a high quality maple syrup. Further, the mouthfeel of these syrups were virtually identical to the conventional syrups that they simulated. The flavor of these syrups was so mild that they were easily ‘morphed into’ the flavor profile of the targeted conventional syrup by the facile addition of an intense sweetener and an appropriate, available commercial flavoring.

### EXAMPLE 1

### High Fiber, High Solids Syrup (“LVDF Syrup”)

LVDF (FIBERSOL, Matsutani, 65 parts by weight) was dispersed in (distilled) water (35 parts by weight), sheared to disperse, and heated to 60° C., and held, with agitation at this temperature until it cleared. The composition was prepared in accordance with Table 1, below, with all percentages given in weight percentages. A significant decrease in viscosity was seen as the turbidity disappeared. It was then ready for use as described herein. It should be noted that this heating could also function as a pasteurization or sterilization.

TABLE 1

| Ingredient | Supplier | Wt. % |
|---|---|---|
| LVDF | Matsutani | 65.0 |
| Water | n/a | 33.7 |
| Aspartame | NutraSweet | 0.3 |
| Maple Flavor | McCormick | 1.0 |
| | Total | 100% |

A serving of this syrup (two tablespoons) provides the nutritional profile, as compared with real maple syrup as indicated in Table 2, below:

TABLE 2

| Product | Carbohydrates (g) | Calories | Fiber (g) |
|---|---|---|---|
| Vermont Maple | 19.5 | 78 | 0 |
| Syrup | | | |
| Product of | 4.1 | 16.4 | 15 |
| Example 6 | | | |

The fact that a syrup of such high solids content can be made, which is yet pourable, is quite unexpected. The copious product listings in Matsutani's patents makes it clear that they had not foreseen it. If they had, since it is so unexpected in a substance with a molecular weight from about 510 to 965, and since such a physical property would have such broad practical utility, they would surely have described it and claimed it, had they seen it. Therefore, we take their silence as proof of the novelty of our finding.

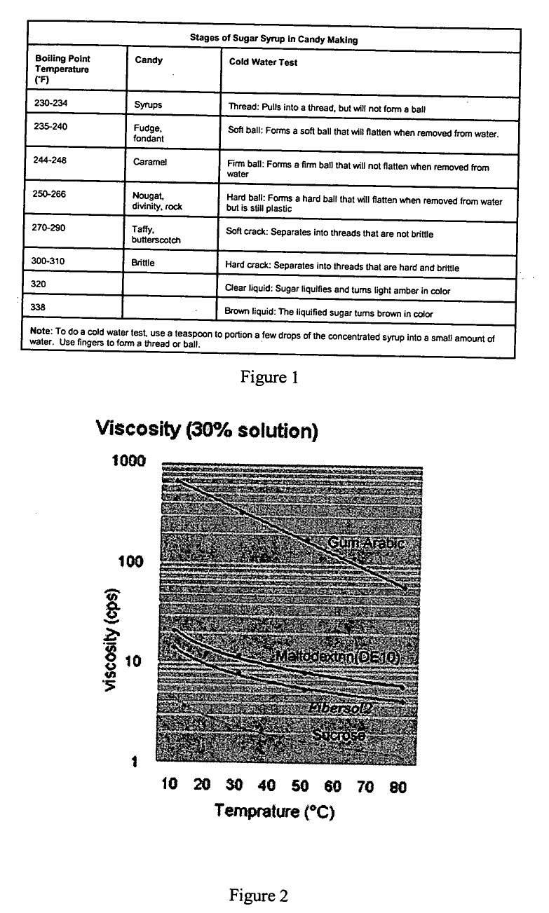

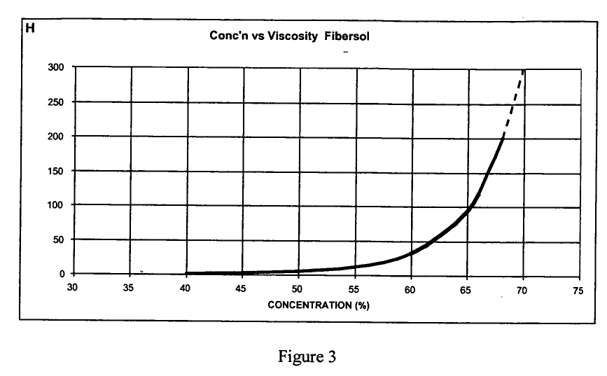

For example, Matsutani U.S. Pat. No. 5,358,729 (the only one providing any viscosity data) shows the viscosity of their product in comparison with sucrose, maltodextrin (presumably Dextrose Equivalent (DE) 10, as identified on www.matsutani.com), and gum Arabic. FIG. 1. However, this comparison shows these viscosities at a dextrin concentration of only 30%, (strangely, the concentrations of the other materials are not identified). This same graphic evidence is reproduced on their website. Nowhere in their data have I been able to find a definition of the viscosity versus concentration of the disclosed dextrin solutions. FIG. 3 represents the viscosity data obtained from a viscosity assay of the dextrin disclosed in the Matsutani references, at about 20° C.

In Matsutani's listing of food products (referenced earlierset forth in the Matsutani references), every one of the products contains the “Indigestible dextrin” at a relatively low level (3 to 50% of the dry substance of the foodstuff) or at levels thatwhat might be called a “fiber additive”. In contrast, what we have seen is that this dietary fiber can be concentrated enough to afford osmotic preservation, while at the same time, remaining fluid enough to be pourable, in traditional terms. Further, the flavor and mouthfeel of this syrup is so very pleasing that it can readily be colored and flavored to be indistinguishable from conventional maple syrup. Alternatively, it can be formulated to provide a convincing honey syrup, or any of a variety of traditional sensory impressions. The resulting ‘syrups’ are then such as can be added to conventional foods as a means of simultaneously enhancing both the flavor and mouthfeel of that food as well as adding a substantial portion of the recommended daily intake of dietary fiber. This combination of convenience, sensory enhancement and dietary advantage has not heretofore been achieved in the field of high fiber products.

As this graph shows, the viscosity of Fibersol is, in fact, very low, at concentrations below about 55%, but thereafter rises sharply. That the high end of the relationship was not identified by the supplier, conjecture can only have been the result of their concern over the implied inutility of these higher viscosities, as this portion of the concentration/viscosity curve would seem to detract from their “Low viscosity” positioning. However, we have found that, while this curve does indeed rise sharply, the solutions remain fluid, and in fact, distinctly pourable. For reference, points “1” and “2” indicate the viscosities of commercial brands of Maple Syrup, and Honey, respectively. Thus, this portion of the curve, (which fortunately embraces the region of osmotic microbial stability) is in fact a region of great practical utility. It is this fortuitous combination of high solids (and therefore osmotic microbial stability) coupled with pourability to which we claim proprietary ownership.

We further found that this prepared FiberSol syrup (FSS) can be used to great advantage to replace corn syrup in the manufacture of a variety of confections.

The simplest example is the preparation of a LVDF-Doctored hard candy.

### EXAMPLE 2

### A High-Fiber Candy Doctor

A high fiber candy doctor was compounded by mixing sucrose, low viscosity dietary fiber (FIBERSOL 2, Matsutani) and maple flavor set forth in Table 3, below.

TABLE 3

| Ingredient | Wt. % |
|---|---|
| Sucrose | 69.0 |
| LVDF (Matsutani) | 30.00 |
| Maple Flavor (McCormick) | 1.0 |

These proportions are calculated as final composition, after initial syrup preparation and boiling to ‘dryness’. The flavoring is added after cooking and partial cooling to avoid aroma waste.

The mixture was filled into round molds, about 1″ diameter. When cooled, the attractive candies easily de-molded. When placed in the mouth, they were glass-smooth, slow to dissolve, pleasantly sweet, with an attractive maple flavor. There was no aftertaste, and no residual mouth feelings. Each such candy weighed about 7 grams, of which about 2 g were soluble dietary fiber. Therefore, the consumption of about 6 such candies would provide about 12 g dietary fiber, an amount that would, on average, bring the US dietary fiber intake up to the level recommended for good intestinal health.

In a manner similar to conventional practice with traditional hard candy formulations, such candy can also be used as a glaze.

We found a unique application by wrapping a thin, hard candy shell (made from a compound sucrose/fibersol syrup) around a freeze-dried fruit such as strawberries. Of course, many other fruits could also be used in this way, including other freeze-dried berries, cherries, freeze-dried balls cut from apple, melon, papaya, mango, etc. or freeze-dried slices of banana. These non-berry fruits can also be cut into shapes such as julienne or flakes, (before drying and coating) in which forms they would be especially attractive as garnishes for cake-decorating and food service.

Using the product of Example 2, a glaze was prepared with the same ratio of dietary fiber to sugar as is found in the fruit itself: i.e. 30%. Thus, regardless of the weight of glaze added to the strawberries, the final ‘Proximate Composition’ of the product remains “Fiber, 30% of total carbohydrates”. This claim has not heretofore been possible.

Of course, a similar product can also be prepared using conventional hard candy formulas, but while it will also be novel, and will have the improved appearance, much of the improved texture and flavor, it will lack the improved mouth feel, the non-hygroscopicity as well as the contribution of dietary fiber. Nonetheless, it will still be found to be of interest in certain market segments.

### EXAMPLE 3

### Glazed Dry Fruits

The syrup of Example 1, (30 parts by weight) was combined with a sugar (sucrose) syrup of the same solids content (70 parts by weight) and cooked to a boiling temperature of 160-170° C. and held at about 150° C. while it was used to coat freeze-dried strawberries, by dipping the fruit (held on a fondue fork that had been modified by removing the barb) into the hot syrup and spreading the coating with a small spatula onto all portions of the surface of the berry. Immediately after coating, the coated fruit was lightly sprayed with a lecithinated oil and rotated under a stream of air hot enough, and for a sufficient time to anneal the coating. The coated berries were then allowed to cool. When cooled to 25° C., the coated fruit was seen to be bright, glossy (fresh-looking) and to have a pleasing crisp, crunchy clean texture, and a distinctly improved flavor as compared to the uncoated dry fruit. By “distinctly improved flavor” we refer to a more intense strawberry aroma, a more balanced sugar-acid ratio, and a crisp clean texture and clean mouthfeel rather than the dry-foam texture and powdery, drying mouth-feel of the original freeze dried fruit.

Further, the coated fruit pieces demonstrated vastly superior resistance to breakage and crushing. Further still, unlike un-coated fruit which is well-known to be highly hygroscopic, the coated fruit was not.

While these coatings can be applied by means of the type of equipment that is used to apply ‘caramel’ coatings onto popped corn, sugar frostings onto breakfast cereals, and candy shells onto chocolate, freeze-dried fruit embodies combinations of characteristics that are unlike any of these other individual food materials. For example, freeze dried fruits are both readily-hydratable (like pop corn) and thermoplastic, (like chocolate). Thus, special consideration must be given to the design of conditions and coating equipment so that neither of these frailties are invoked.

Another surprising aspect of this work is the finding that, while it is made without any added fat, it has the sort of “short” texture one would normally only get with a fatty candy (e.g. peanut brittle, praline). Therefore, this new form of hard candy holds considerable promise in the preparation of products with high sensory qualities, and low fat levels.

### EXAMPLE 4

### Non-Fat Banana Chips

The hard candy glaze of Ex. 3 was used to coat Freeze Dried Banana Slices. When cooled, they had a rich banana flavor and a crisp clean texture very similar to conventional “Banana Chips”. However, conventional “Banana Chips” are prepared by frying slices of plantain (a starchy relative of banana with a low level of banana flavor). They therefore carry a burden of about 20 to 35% fat. In contradistinction, the product of Ex. No. 4 is fat free, yet is at least as pleasing to the palate as the full-fat conventional product.

Sugar syrups (and sugar alcohols) have been used since quite ancient times to provide a sufficiently high osmotic effect to retard or obviate the growth of micro-organisms. Examples of such classically-produced osmotically-protected products would include: fruit preserves, glacé fruits, fruit leathers, meat jerkys, sugar-cured ham or mincemeat.

However, in each case, the sweetness of the sugar plays a prominent, even dominating role in the product's flavor. The sugar also contributes prominently to both caloric content and glycemic index.

These burdens limit the breadth of utility for this approach to protecting food from spoilage.

Therefore, it seemed to us that a non-sweet, low-glycemic means of obtaining this effect would have a real appeal considering current consumer awarenesses and sensitivities.

### EXAMPLE 5

### Non-Sweet Osmotic Protection

Subsequently, we found that the inventive LVDF composition has a range of utility broader than the production of simple syrups and confections. Analogous to conventional practice, with common sugars (typically sucrose, glucose and/or fructose) the present invention can be used as aids to food preservation, wherein, in addition to enabling the attainment of a solids content sufficiently high to inhibit bacterial growth, Employing the inventive LVDF composition will deliver certain novel properties in addition to supplying needed supplemental dietary fiber. Examples of this class of application include: Jams, jellies, preserves, Fruit ‘butters’, Fruit leathers, Snack meat products, such as beef jerky or dried sausages such as SLIM JIMS, mincemeat, gum candies, caramels or marshmallows.

### EXAMPLE 6

### Non-Sweet Cryoprotection

In more recent times, sugars, and sugar alcohols have been used to protect foods from the physical damages produced by freezing. In the course of freezing a biological tissue (either plant or animal) for use as food, the water in such tissues freezes. It is in the nature of ice crystals that the larger ones grow at the expense of the smaller. As the ice crystals grow, they pierce cell walls, and over time compress the non-aqueous components of the tissues which become compressed ever more tightly between the advancing ice “plates”. When such tissue is allowed to defrost, the ice plates melt, forming ‘puddles’ of almost pure water amongst the debris that previously had been the organized tissue structure. When such food material is eaten, it is experienced as having been significantly changed in texture. The exact nature of this textural change will depend upon the food material in question. It will be either tough and watery or simply ‘mushy’. In a well-known classical case, when un-protected egg yolk is frozen and defrosted it is found to have become tightly gelled. The addition of about 20% sucrose to the yolk before freezing is known to be sufficient to prevent this unwanted change. In an analogous fashion, sugars or sugar alcohols have been mixed into or infused into a variety of food materials to prevent unwanted textural changes caused by freezing. Once again, the sugar contributes a prominent sweetness and a glycemic burden that limit the breadth of usefulness of this approach.

Therefore, we explored the possibility of using LVDF syrup in lieu of sugars or sugar alcohols to accomplish this ‘cryoprotection’.

LVDF was blended into freshly-separated egg yolks, at levels ranging from 0.1 to 20%. The prepared samples were frozen, held frozen for 2 days, defrosted at room temperature and examined. A sample of un-treated yolk was used as control, and a sample into which had been blended 20% sucrose (as experimental control) were also frozen and defrosted in the same way. We found that gellation was prevented by the incorporation of 20, 15 and 10% LVDF. While the apparent viscosity of the LVDF/yolk was higher than that for the sugar/yolk, the LFDF/yolk was still fluid enough to be pumpable. When a spatula was drawn through it, to make a groove, the walls of the groove sagged, flowed downwards. Whereas, when the same was done to the untreated yolk, the walls of the groove remained in place.

This same protection may be afforded to other food materials as well, including: surimi (i.e., mechanically-de-boned raw fish meat pate), lunch meats, pates or fruits.

We have now shown that LVDF or the inventive LVDF syrup can replace sugars and sugar alcohols as the means to preserve textural integrity through the freezing process.

There is currently a ground-swell of discontent with high-intensity sweeteners. This seems to grow out of recent findings that point to their health hazards as well as to their limited shelf stability (as in the case of aspartame), and their inutility for replacing high sugar levels (as is the case with chlorinated sucrose) or the presence of bitterness (as is the case with stevia). Therefore, we sought to discover if it were also possible to formulate a syrup without the need for high-intensity sweeteners. As shown in the following example, that was indeed possible.

### EXAMPLE 7

### Low Glycemic, High Fiber Flavored Syrup

A high fiber flavored syrup having a low glycemic index was compounded by mixing fructose, erythritol, FIBERSOL 2, water and maple flavor set forth in Table 4, below.

TABLE 4

| Ingredient | Wt. % |
|---|---|
| Fructose | 28.6 |
| Erythritol | 16.2 |
| LVDF (FIBERSOL-2, Matsutani) | 19.5 |
| Distilled Water | 45.0 |
| Maple Flavor | 1.0 |

The fructose, erythritol, LVDF and water were mixed and heated with stirring to the boiling point. Boiling was sustained until a solids content of 65% was attained, whereupon the pot was removed from the heat, the flavor blended in, covered, and cooled to about 150° F., whereupon it was filled into bottles, which were then capped and inverted. The resulting product was shelf stable, had a pleasing level of sweetness and maple flavor, a very desirable viscosity, a natural pouring character and a satisfying mouthfeel.

A serving of 2 tablespoons weighed 37 g, of which 6.5 g was dietary fiber, supplying about half the average fiber supplement reported to be needed in this country.

The choice of fructose and erythritol as the contributors of both sweetness and soluble solids assures that the product also has a very low glycemic index.

### EXAMPLE 8

### Low Glycemic, High Fiber Hard Candy

A high fiber, low glycemic index hard candy was made by compounding LVDF (FIBERSOL-2, Matsutani) (22.2 wt %) with Isomaltitol (44.4 wt %), erythritol (7.4 wt %) as a sweetener, and water 26.0 wt %) and boiling the mixture until it reached 170° C. After being allowed to cool to 150° C. at which temperature, a maple syrup flavoring (McCormick, 1 wt. %) was mixed in. The hot LVDF syrup was poured intomolds and allowed to cool. The candy was smooth, pleasingly sweet, non-sticky, and left no aftertaste. After cooking, the final composition was Isomaltitol (60 wt. %), LVDF (30 wt. %) and erythritol (10 wt. %).

### EXAMPLE 9

### Low Glycemic, High Fiber Glazed Fruit

The LVDF syrup of Example No. 8 was prepared, cooled to about 150° C. and maintained while various dried fruit was coated. The coated fruit pieces were sprayed with a lecithinated oil and and rotated under a stream of air hot enough, and for a sufficient time to anneal the coating. The sensory qualities of the resulting product were essentially the same as found in the sucrose-based product described in Example 3. The product of this Example, however, would be considered to have a low glycemic index.

Thus, those of ordinary skill in the art will understand and appreciate that the foregoing describes a product and method for formulating a low viscosity dietary fiber syrup that is capable of multiple uses to make and treat foodstuff. The product and method of the present invention permits the making of foodstuffs which exhibit both excellent levels of dietary fiber, while, at the same time preserving or enhancing the taste or palatability of the foodstuff. Additionally, foodstuffs having both high levels of dietary fiber and low glycemic index values may be made with product and method of the present invention.

It will be understood, therefore, that the present invention may include the following products and methods:

a. Syrups: LVDF syrup is useful with flavoring and sweeteners as a syrup topping as with any conventional syrup such as maple syrup, caramel or honey. The inventive LVDF syrup may be flavored for use as a variegating syrup in frozen confections. Since the simple unsweetened LVDF syrup is not sweet, it may be used as a base for savory syrup-form condiments.

b. Hard Candy: Hard candies having improved sensory character and high fiber content.

c. Confectionery Glaze: The LVDF syrup is useful when made into consistencies ranging from caramel through to toffee and hard-crack confections and used may be applied as a coating to baked confections, or coated onto fresh or dried fruits to provide a range of confections with a high content of dietary fiber.

d. Low-Fat versions of Fatty Confections: Classical confections, such as Pralines and Nut Brittles have a shorter cleaner-biting texture than conventional hard candies, which is understood to be a consequence of their high fat content. This character is believed to have contributed to their long popularity. We have found that comparably attractive textures can be created, at much lower or near zero fat contents by doctoring the sucrose in such reduced fat content formulas with LVDF.

e. Carrier (or “support”) for Drying Heat Labile Flavors and Biologicals; Many flavors and biologicals become changed in undesirable ways when they are dried. This is believed to be a consequence of the large amount of energy (usually heat and especially when in the presence of oxygen in the air used to heat the product and carry away the moisture) that must be applied in order to drive off enough moisture to render the composite mass dry, and to confer stability to the material when stored. The inventive LVDF syrup readily looses moisture, resulting in less heat-exposure to the heat labile burden, and consequently greater conservation of its desirable properties.

f. Sucrose-Replacement: The sucrose component of the LVDF syrups may be replaced by a variety of other sugars, including fructose, trehalose, erythritol, other sugar alcohols, “Palatinate” and de-colored, de-flavored fruit syrups. The addition of LVDF syrup to each of these produces characteristic shifts in the functional properties of the resulting compound syrup that bring them closer to the character of sucrose-based products, the utilities of which will be obvious to one skilled in the confectionary arts, once the teachings contained herein are understood.

While it will be understood by those of ordinary skill in the art, that the foregoing embodiments are described with reference to their preferred embodiments, it will be understood that the Examples provided are intended merely to illustrate particular formulations and uses of the present invention, and are not limiting of the present invention, which is limited only by the scope of the claims appended hereto.

What is claimed is:

1. An edible syrup composition comprising a low viscosity, non-digestible fiber component thereof.

2. The edible syrup composition of claim 1, wherein the low viscosity non-digestible fiber component is present in the composition in the range of about 20 to about 96% by weight of the final composition.

3. The edible syrup composition of claim 1, wherein the low viscosity non-digestible fiber component further comprises dextrin.

4. The edible syrup composition of claim 1, further comprising at least one of a sweetener and a flavorant.

5. The use of the edible syrup composition of claim 1 in formulating an edible maple syrup.

6. The use of the edible syrup composition of claim 1 in formulating hard candy.

7. The use of the edible syrup composition of claim 1 in formulating a confectionary glaze.

8. The use of the edible syrup composition of claim 1 in formulating baked goods.

9. The use of the edible syrup composition of claim 1 in formulating coatings for fresh or dried fruits.

10. The use of the edible syrup composition of claim 1 in formulating a syrup food additive.

11. The use of the edible syrup composition of claim 1 in producing dried proteinaceous foodstuff

12. The use of the edible syrup composition of claim 1 as a beverage additive.

13. The use of the low viscosity, non-digestible fiber of claim 1 as a beverage additive when used at a level of about 0.5 to about 20% of the beverage to improve blendedness and to confer mellowness to the flavor of the alcoholic, non-alcoholic, carbonated or non-carbonated beverage.

14. A method for preserving frozen foodstuffs, comprising the step of adding a low viscosity, non-digestible fiber component thereto prior to freezing.

15. The method for preserving frozen foodstuffs of claim 14, further comprising the step of adding a low viscosity, non-digestible fiber to the foodstuff at between about 10 to 20 wt %.

16. An edible composition comprising, in combination, low viscosity, non-digestible fiber and a foodstuff selected from the group consisting of beverages, yogurt, coffee whitener powder, candy, chewing gum, jelly, jam, cereals, pasta, donuts, cookies, cakes, pies, soup, meat stew, salad dressings, peanut butter, eggs, meat, and meat sausages.
